(19) United States
(12) Patent Application Publication
(10) Pub. No.: US 2014/0019278 A1
(43) Pub. Date: Jan. 16, 2014

(54) METHOD FOR SELLING GENUINE GOODS

(71) Applicant: Juichin Lee, Taipei City (TW)

(72) Inventor: Juichin Lee, Taipei City (TW)

(21) Appl. No.: 14/029,812

(22) Filed: Sep. 18, 2013

Related U.S. Application Data
(63) Continuation-in-part of application No. 12/938,358, filed on Nov. 2, 2010.

(51) Int. Cl. G06Q 30/00

(52) U.S. Cl. CPC G06Q 30/0185
USPC 705/23; 705/318

(57) ABSTRACT

A method for selling genuine goods by a barcode and network is disclosed. The method includes the steps of: a) generating a barcode for a product; b) attaching the barcode on the product and registering the barcode and the product in a server; c) a retailer updating the server to render the product sellable by reading and sending the barcode; d) a customer reading the barcode and sending to the server for verifying the product; e) the server answering if the product is genuine or not; f) informing the customer not to buy the product when the product is not genuine; g) informing the customer the product is OK when the product is genuine; and h) the retailer updating the server to render the product unsellable when the product has been sold.

### BACKGROUND OF THE INVENTION

1. Technical Field

The invention relates to business methods, particularly to a method for selling goods with genuineness verification.

2. Related Art

There always is a very serious problem in the markets for manufacturers and customers, which is omnipresence of fake goods. With advances of technologies, forgeries are much harder to be distinguished from genuine goods than ever. A conventionally popular solution is to attach an anti-forgery tag on a genuine product. However, it is possible that such an anti-forgery tag is forged. In other words, an anti-forgery tag is not completely secure. Buying forgeries will make losses of manufacturers and customers. On the other hand, an anti-forgery tag also increase tangible cost of a product, and the higher the quality of an anti-forgery tag is, the higher the cost of an anti-forgery tag is. This is a problem which should be solved as soon as possible.

### SUMMARY OF THE INVENTION

An object of the invention is to provide a method for selling genuine goods, which is completely secure and will not increase tangible cost to a product.

To accomplish the above object, the method of the invention includes the steps of: a) generating a barcode for a product; b) attaching the barcode on the product and registering the barcode and the product in a server; c) a retailer updating the server to render the product sellable by reading and sending the barcode; d) a customer reading the barcode and sending to the server for verifying the product; e) the server answering if the product is genuine or not; f) informing the customer not to buy the product when the product is not genuine; g) informing the customer the product is OK when the product is genuine; and h) the retailer updating the server to render the product unsellable when the product has been sold.

### BRIEF DESCRIPTION OF THE INVENTION

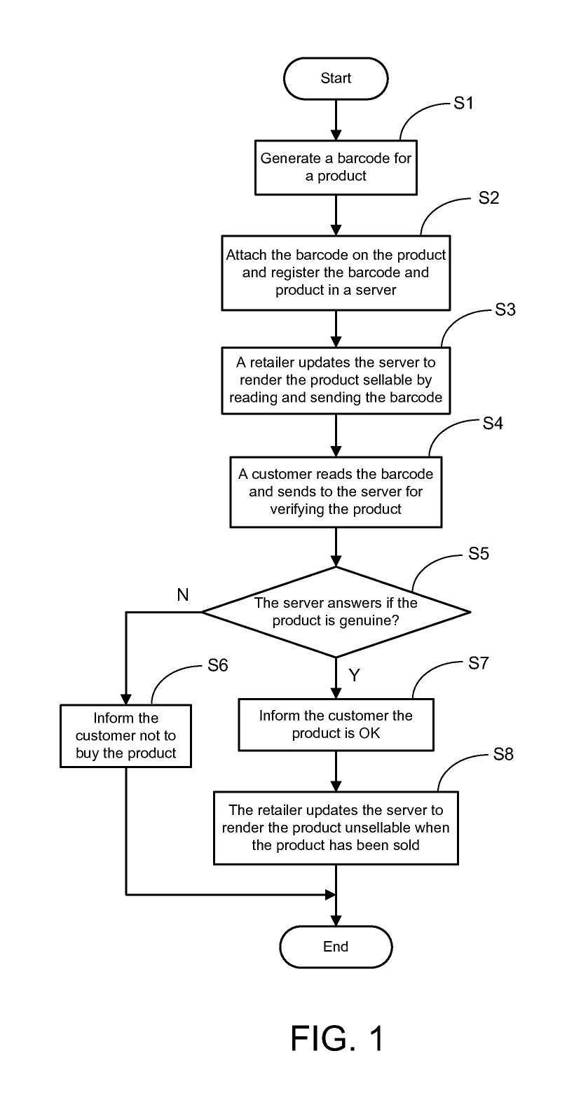

FIG. 1 is a flowchart of the invention; and

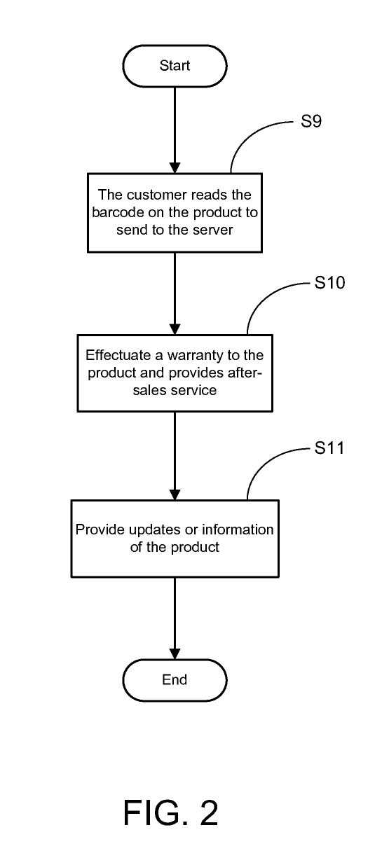

FIG. 2 is a flowchart of an additional process of the invention.

### DETAILED DESCRIPTION OF THE INVENTION

Please refer to FIG. 1, which shows a flowchart of the method of the invention. The invention provides a method for selling genuine goods. Initially, a manufacturer generates a barcode for a product in step S1. The barcode, which may be a one-dimensional barcode or a two-dimensional barcode, is unique and represents the product. The barcode is attached on the product and the barcode and the product are registered in a server in step S2. In detail, there is a product database in the server, and information of all products is stored in the product database.

After the product is transported to a retailer, the retailer updates the product database of the server to render the product sellable in the product database by reading and sending the barcode on the product in step S3. In other words, the server knows where the product is now. When the retailer is equipped with a Point of Sale (POS) system, the retailer may use the POS system to execute step S3 because a POS system possesses a network to connect the retailer and the server provided by the manufacturer. When the retailer is not equipped with a POS system, the retailer may use a mobile computing device such as a smartphone or tablet computer to execute step S3. Of course, the smartphone or tablet used by the retailer must be installed with a proprietary application provided by the manufacturer of the product in advance.

A Point of Sale (POS) system is a system for managing the sales of retail goods. The term is used to refer to the software and hardware associated with check out stands, and all of the bundled features which are included. Most retailers use this type of system at their checkstands or counters, and several major manufacturers offer ones designed for various types of businesses, ranging from grocery stores to clothing boutiques. Using a POS system makes a business much more efficient, lowering the costs of doing business while improving customer service and making the environment more pleasant to work in.

When a customer comes to the retailer and would like to buy the product, the customer reads the barcode on the product and sends it to the server for verifying the product in step S4. When the retailer is equipped with a POS system, the customer may ask the retailer to use the POS system for reading and sending the barcode of the product wanted by the customer. When the retailer is not equipped with a POS system, the customer may use his or her mobile computing device such as a smartphone or tablet computer to read and send the barcode of the product wanted by the customer. Of course, the smartphone or tablet used by the customer must be installed with a proprietary application provided by the manufacturer of the product in advance.

After that, in step S5, the server will answer if the product is genuine or not according the information of the product database in the server. Then the server will inform the customer not to buy the product when the product is not genuine in step S6. Meanwhile the server will inform the customer that the product is OK when the product is genuine in step S7. The customer is able to simply determine to buy or not to buy the product according to the result answered by the server.

When the product is OK and the customer decides to buy the product, the retailer will update the server to render the product unsellable any longer in the server while the product is being checked out in step S8. Similarly, the step S8 can be performed by reading the barcode of the product and sending it to the server. And the step S8 may also be executed by a POS system or a mobile computing device.

As abovementioned, the invention can simply and completely verify whether a product is genuine or not. And no anti-forgery tag is required. This will not increase cost of the product.

There may be an additional process after the step S8. Such an additional process can automatically provide more complete service. Please to FIG. 2, after the step S8 (the customer has bought the product), the customer reads the barcode on the product to send it to the server in step S9. The customer may use his or her mobile computing device such as a smartphone or tablet computer to perform the step S9. Of course, the smartphone or tablet used by the customer must be installed with a proprietary application provided by the manufacturer of the product in advance. After step S9, the server will effectuate a warranty to the product and provides after-sales service in step S10.

A step S11 may be added after the step S10, the server can provide updates or information of the product to the mobile computing device of the customer.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for selling genuine goods, comprising the steps of:
a) generating a barcode for a product;
b) attaching the barcode on the product and registering the barcode and the product in a server;
c) a retailer updating the server to render the product sellable by reading and sending the barcode;
d) a customer reading the barcode and sending to the server for verifying the product;
e) the server answering if the product is genuine or not;
f) informing the customer not to buy the product when the product is not genuine;
g) informing the customer the product is OK when the product is genuine; and
h) the retailer updating the server to render the product unsellable when the product has been sold.

2. The method of claim 1, wherein the step c) is performed by a Point of Sale (POS) system.

3. The method of claim 1, wherein the step c) is performed by a mobile computing device.

4. The method of claim 1, wherein the step d) is performed by a Point of Sale (POS) system.

5. The method of claim 1, wherein the step d) is performed by a mobile computing device.

6. The method of claim 1, wherein the step h) is performed by a Point of Sale (POS) system.

7. The method of claim 1, wherein the step h) is performed by a mobile computing device.

8. The method of claim 1, after the step h), further comprising the steps of:
i) reading the barcode on the product to send to the server; and
j) effectuating a warranty to the product and providing after-sales service.

9. The method of claim 8, after the step j), further comprising the steps of k) providing updates or information of the product.

10. The method of claim 8, wherein the step i) is performed by a mobile computing device.
